(19) United States
(12) Patent Application Publication
(10) Pub. No.: US 2022/0285699 A1
(43) Pub. Date: Sep. 8, 2022

(54) METHOD FOR MANUFACTURING A SEPARATOR FOR AN ELECTROCHEMICAL REACTOR AND SEPARATOR FOR AN ELECTROCHEMICAL REACTOR

(71) Applicant: ALSTOM Hydrogène SAS, Aix En Provence (FR)

(72) Inventors: Benoit GUENOT, Aix En Provence (FR); André RAKOTONDRAINIBE, Aix En Provence (FR); Bruno GENTILS, Tourves (FR)

(21) Appl. No.: 17/685,131

(22) Filed: Mar. 2, 2022

(30) Foreign Application Priority Data
Mar. 5, 2021 (FR) 21 02164

(51) Int. Cl. H01M 8/0247; H01M 8/0271; H01M 8/0297; H01M 8/0258

(52) U.S. Cl. CPC H01M 8/0247; H01M 8/0271; H01M 8/0297; H01M 8/0258

(57) ABSTRACT

Disclosed is a manufacture method including providing a separator plate including a distribution face configured to channel a fluid along a face of a membrane/electrode assembly applied against the separator plate, and applying a sealing film to the distribution face of the separator plate to seal between the separator plate and the membrane/electrode assembly and/or a further separator sandwiching the membrane/electrode assembly with the separator the sealing film being adhesive on a first face facing the separator plate to adhere thereto and non-adhesive on a second face opposite the separator plate.

### BACKGROUND OF THE INVENTION

### Field of the Invention

The present invention relates to the field of electrochemical reactors comprising a stack of separators and membrane/electrode assemblies defining electrochemical cells.

### Description of the Related Art

Such an electrochemical reactor is a fuel cell for producing electricity by electrochemical reaction between an oxidant and a fuel, for example, or an electrolyzer for separating chemical elements from a fluid using electricity, for the production of dihydrogen and dioxygen from water, for example.

In such an electrochemical reactor, each membrane/electrode assembly takes the form of a laminate comprising an ion exchange membrane interposed between two electrodes.

Each separator has the form of a plate, with at least one of the two faces of the separator configured to be applied against one face of a membrane/electrode assembly to channel a fluid such that it flows along said face of the membrane/electrode assembly.

Each electrochemical cell is defined by a membrane/electrode assembly interposed between two separators, with each separator defining a fluid chamber with the face of the membrane/electrode assembly against which it is applied, the electrochemical reaction being achieved by ion exchange between the fluid chambers, through the membrane/electrode assembly.

Each separator has openings through the separator, for example, provided to form at least one inlet manifold in the stack, for supplying fluids to fluid chambers of the electrochemical cells, and at least one outlet manifold, for recovering fluids from the fluid chambers.

To ensure the operation of the electrochemical reactor, it is necessary to ensure the seal between each face of the membrane/electrode assembly and the separator applied against this face of the membrane/electrode assembly and/or between the two separators of a same electrochemical cell.

To do so, it is possible to deposit a seal on a sealing area of each separator, in the form of a sealing bead.

However, depositing such a seal is costly, even if done robotically, and leads to a non-negligible scrap rate, particularly if the seal is not correctly arranged on the sealing area or if the shape of the seal is not controlled.

### SUMMARY OF THE INVENTION

One of the objects of the invention is to propose a method for manufacturing an electrochemical reactor separator that is easy and economical to manufacture, while obtaining a satisfactory seal.

To this end, the invention proposes a method for manufacturing a separator for an electrochemical reactor formed of a stack of separators and membrane/electrode assemblies defining superimposed electrochemical cells, the manufacturing method comprising providing a separator plate comprising a distribution face configured to channel a fluid along a face of a membrane/electrode assembly applied against the separator plate, and applying a sealing film to the distribution face of the separator plate to ensure the seal between the separator plate and the membrane/electrode assembly and/or another separator sandwiching the membrane/electrode assembly with the separator, the sealing film being adhesive on a first face, facing the separator plate, to adhere thereto, and non-adhesive on a second face, facing away from the separator plate.

Applying a sealing film to the separator plate to form the separator makes it possible to apply the sealing film to separator plate sealing areas intended to come into sealed contact with a membrane/electrode assembly or another separator, in a quick and economical manner. The sealing is controlled, in particular because the sealing film thickness can be controlled easily. The non-adhesive sealing film face makes it possible to disassemble the separator, during stack manufacture or for maintenance operations performed on the stack, for example.

According to particular embodiments, the manufacturing method comprises one or several of the following optional features, taken individually or in any technically possible combination:

the sealing film is pre-cut, so as to provide openings in the sealing film before being applied on the separator plate;

the sealing film is applied on the separator plate by means of a sealing press, configured to press the sealing film against said distribution face of the separator plate;

the sealing press comprises two sealing press parts, movable relative to each other between an open position, making it possible to position the sealing film and the separator plate between the two pressing parts, and a closed position, making it possible to press the sealing film against the separator plate;

the sealing film is provided as a single sheet or as a sealing web comprising a series of sealing films;

the method comprises assembling the separator plate with another separator plate by superimposing and assembling two separator plates by means of an adhesive film, adhesive on both sides, interposed between the two separator plates;

the adhesive film is pre-cut so as to provide windows in the adhesive film before it is interposed between the two separator plates;

the adhesive film is provided in the form of a sheet or in the form of an adhesive web comprising a series of adhesive films;

the adhesive film has a thickness strictly less than that of the sealing film applied to the separator plate;

the other separator plate is provided with a sealing film on its distribution face facing away from the separator plate, with this sealing film adhesive on its first face, facing the other separator plate, to adhere thereto and non-adhesive on its second face, facing away from the other separator plate.

The invention also relates to a method for producing an electrochemical reactor formed of a stack of separators and membrane/electrode assemblies defining superimposed electrochemical cells, with the stack produced by using one or more separator(s) obtained according to a manufacturing method as defined above.

The invention further relates to an electrochemical reactor separator comprising a separator plate having a distribution face configured to channel a fluid along a membrane/electrode assembly face applied against this distribution face, and a sealing film deposited on the distribution face of the separator plate, to ensure the seal with the membrane/electrode assembly and/or with another separator sandwiching the membrane/electrode assembly with the separator, the sealing film being adhesive on its first face, facing the separator plate, in order to adhere thereto, and non-adhesive on its second face, opposite the separator plate.

According to particular embodiments, the separator comprises one or more of the following optional features, taken individually or in any technically possible combination:

the separator comprises another separator plate assembled with the separator plate by means of an adhesive film interposed between the two separator plates;

the other separator plate has a distribution face on the side opposite the separator plate, the separator comprising a sealing film deposited on the said distribution face of the other separator plate, with this sealing film being adhesive on its first face, facing the other separator plate, in order to adhere thereto, and non-adhesive on its second face, opposite the separator plate.

The invention also relates to an electrochemical reactor formed of a stack of separators and membrane/electrode assemblies defining superposed electrochemical cells, the stack including one or more separator(s) as defined above.

### BRIEF DESCRIPTION OF THE DRAWINGS

The invention and advantages thereof will be better understood upon reading the following description, given only as a non-limiting example, and made with reference to the appended drawings, in which:

FIG. 1 is an exploded perspective view of a stack of separators and membrane/electrode assemblies of a formed electrochemical reactor;

FIG. 2 is a cross-sectional view of one of the separators, according to II-II in FIG. 1;

FIGS. 3 and 4 are schematic views illustrating steps in a method for manufacturing the separator of FIG. 2;

FIGS. 5 and 6 are schematic views illustrating steps of another method for manufacturing the separator of FIG. 2; and

FIG. 7 is a cross-sectional view of a separator according to another embodiment.

### DETAILED DESCRIPTION OF PREFERRED EMBODIMENTS

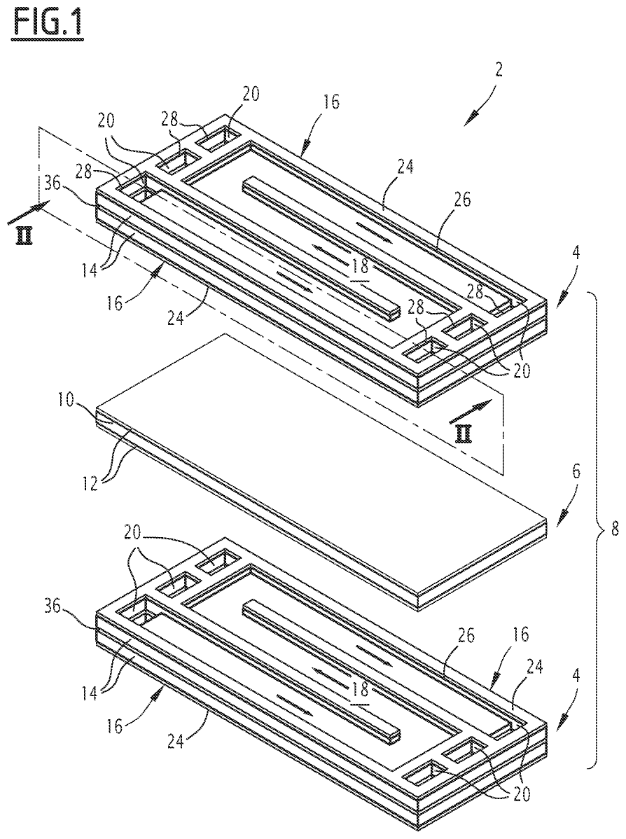

The electrochemical reactor 2 shown in FIG. 1 comprises a stack of separators 4 and membrane/electrode assemblies 6, defining superimposed electrochemical cells 8. Each electrochemical cell 8 is formed by a membrane/electrode assembly 6 interposed between two separators 4.

Only one electrochemical cell 8 is shown in FIG. 1, for clarity of the drawings. In practice, an electrochemical reactor 2 may include several tens or hundreds of electrochemical cells 8 stacked on top of each other.

Each membrane/electrode assembly 6 is in the form of a laminate formed by an ion exchange membrane 10 interposed between two electrodes 12. The ion exchange membrane 10 is a proton exchange membrane (or PEM), for example.

Each separator 4 is configured to channel a fluid along said face of the membrane/electrode assembly 6 for the purpose of electrochemical reaction with exchange of ions between the fluids channeled through the separators 4 on either side of the membrane/electrode assembly 6, with the ions passing through the membrane/electrode assembly 6.

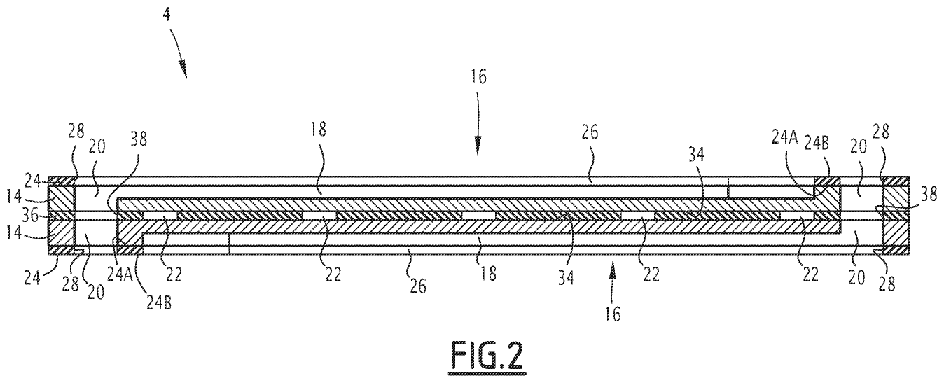

The separators 4 are analogous and only one separator 4 will be described in more detail with reference to FIG. 2.

The separator 4 in FIG. 1 is a bipolar separator, configured to be interposed between two membrane/electrode assemblies 6, channeling a fluid along one face of each of the two membrane/electrode assemblies 6.

When the electrochemical reactor has bipolar separators 4, it is formed by an alternating stack of separators 4 and membrane/electrode assemblies 6.

The separator 4 in FIG. 2 is stratified. It is formed by two superimposed separator plates 14 assembled together.

Each separator plate 14 has a distribution face 16, facing away from the other separator plate 14 of the separator 4 and configured to channel a fluid along a face of a membrane/electrode assembly 6 against which the separator plate 14 is applied (as illustrated by arrows in FIG. 1).

Each distribution face 16 defines a fluid chamber 18 for fluid to flow along the face of the membrane/electrode assembly 6 applied against said distribution face 16.

Each distribution face 16 has channels for fluid to flow along the membrane/electrode assembly 6, for example. The channels form a flow field. The channels define the fluid chamber 18.

Each separator plate 14 has openings 20 intended to form manifolds through the stack.

In the stack, each manifold is in fluid communication with one of the two fluid chambers 18 of each electrochemical cell 8 to supply fluid to the fluid chambers 18 to which it is connected or to recover fluid from the fluid chambers 18 to which it is connected, or with cooling channels 22 (FIG. 2) of the separators 4.

Each separator plate 14 is provided with a sealing film 2, on its distribution face 16, deposited on said distribution face 16 of the separator plate 14.

The sealing film 24 is configured to seal the fluid chamber 18 defined by the distribution face 16 with the membrane/electrode assembly 6 located opposite and to seal the manifolds, if applicable.

The sealing film 24 has lights to allow fluid to flow along the membrane/electrode assembly 6 into the fluid chamber 18 and into the manifolds, if applicable.

For example, a main light 26 is provided in line with the fluid chamber 18 and/or manifold lights 28 are provided in line with the openings 20 defining the manifolds.

The sealing film 24 comprises a substrate, for example, provided on only one of its two sides with an adhesive layer.

The substrate of the sealing film 24 is made of silicone, ethylene-propylene-diene monomer (or EPDM), polyethylene terephthalate (PET) or polyvinyl chloride (PVC), for example. Preferably, it is ethylene propylene diene monomer (or EPDM).

The sealing film 24 has for example a thickness of between 0.50 mm and 0.75 mm, in particular a thickness substantially equal to 0.60 mm.

The adhesive layer is an acrylic adhesive layer, for example.

The sealing film 24 has a first face 24A in contact with the separator plate 14 and a second face 24B opposite the first face 24A, intended to come into contact with a membrane/electrode assembly 6 and/or with another separator 4.

The sealing film 24 is adhesive (or glued) on its first face 24A facing the separator plate 14 to which it is applied, and non-adhesive (or not glued) on its second face 24B facing away from the separator plate 14 to which it is applied.

The sealing film 24 adheres to the separator plate 14. The separator 4 with the sealing film 24 can be manipulated to make the stack without the sealing film 24 separating from the separator 4.

When the stacking is completed, the sealing film 24 does not adhere to the membrane/electrode assembly 6 applied against the separator plate 14 or to another separator 4 sandwiching the membrane/electrode assembly 6.

This allows the stack to be easily disassembled, to remove a defective separator 4 or a defective membrane/electrode assembly 6, for example. It is possible to replace only the defective component, without damaging the other components of the stack.

In operation, the stack is preferably kept compressed, so that the sealing film 24 carried by a separator 4 is applied under pressure against a membrane/electrode assembly 6 or/and another separator 4 sandwiching the membrane/electrode assembly 6 with the separator 4, with sufficient pressure to ensure the seal.

Each separator plate 14 of the separator 4 has an assembly face 34 facing the other separator plate 14 of the separator 4.

The separator 4 comprises an adhesive film 36 interposed between the two separator plates 14 to join the separator plates 14 together. The adhesive film 36 is adhesive on its two opposite sides.

Optionally, the separator plates 14 define said cooling channels 22, provided for the circulation of a cooling fluid between them, which is supplied and recovered via two of the manifolds, for example.

In this case, the adhesive film 36 is preferably configured to seal between the separator plates 14, in particular to seal the manifolds and the cooling channels 22.

The adhesive film 36 is cut in such a way as to form windows making circulation of reactive fluids in the manifolds possible and in the cooling channels 22, if applicable. The adhesive film 36 comprises manifold windows 38, for example, with one manifold window 38 provided at each manifold.

The adhesive film 36 comprises a substrate provided on each of its two sides with an adhesive layer, for example.

The substrate of the adhesive film 36 is made of silicone, ethylene propylene diene monomer (or EPDM), polyethylene terephthalate (PET) or polyvinyl chloride (PVC), for example. Preferably, it is ethylene propylene diene monomer (or EPDM).

The adhesive film 36 has for example a thickness of between 0.20 mm and 0.35 mm, in particular a thickness substantially equal to 0.25 mm.

In one example embodiment, the sealing film 24 and the adhesive film 36 are made of the same material. In a variant, they are made of different materials.

In one example embodiment, the sealing film 24 has a different thickness than that of the adhesive film 36.

Preferably, the sealing film 24 has a thickness strictly greater than that of the adhesive film 36.

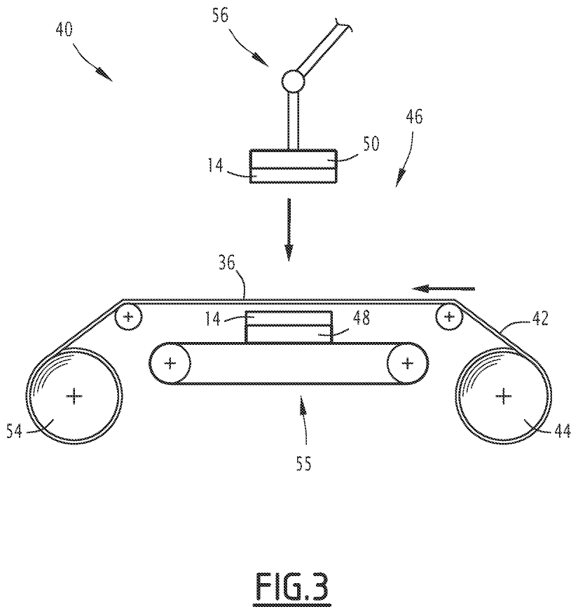

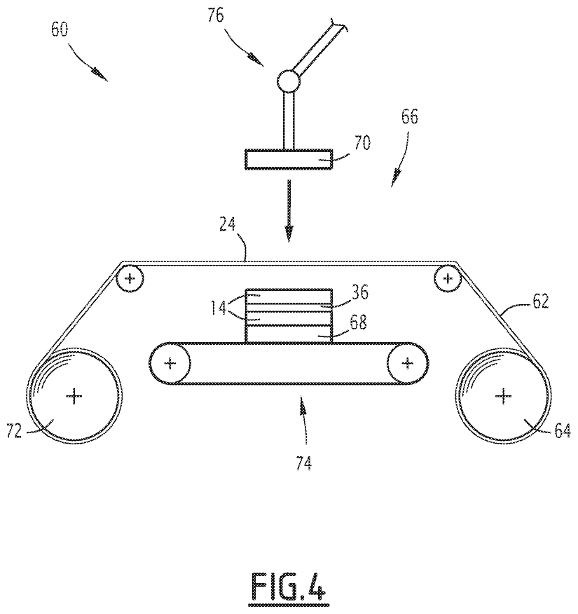

FIGS. 3 and 4 schematically illustrate steps in a method for manufacturing a separator 4 as represented in FIG. 2.

As illustrated in FIG. 3, the method for manufacturing a separator 4 comprises a step of assembling two separator plates 14, using an adhesive film 36. The assembly step is performed at an assembly station 40.

The adhesive film 36 is packaged in the form of an adhesive web 42, the adhesive web 42 being wound in the form of an adhesive roll 44, for example.

In a known manner, the adhesive web 42 is provided on one or both sides thereof with a protective film (not shown), for example, preventing the adhesive web 42 from adhering to itself when rolled up.

For example, the adhesive web 42 is precut to form adhesive films 36 in the adhesive web 42 and to form the necessary windows in each adhesive film 36 of the adhesive web 42.

The pre-cutting of the adhesive films 36 is performed before winding the adhesive web 42 to form the adhesive roll 44, for example. In a variant, it can be performed after unwinding the adhesive roll 44, in a cutting station (not shown) located upstream of the assembly station 40 along the path of the adhesive web 42.

In the illustrated embodiment, the adhesive web 42 is unwound from the adhesive roll 44, a first separator plate 14 is positioned opposite an adhesive film 36 precut from the adhesive web 42, then a second separator plate 14 is applied to the first separator plate 14 so as to sandwich the adhesive film 36 between the two separator plates 14, in order to form an assembly comprising the adhesive film 36 interposed between the two separator plates 14.

Any protective film on the adhesive web 42 is removed prior to applying the adhesive film 36 to the separator plates 14, so that the adhesive film 36 can adhere to the separator plates 14 and provide cohesion between them.

The assembly station 40 comprises an assembly press 46, for example, comprising assembly press parts 48, 50, configured to each support a respective separator plate 14 and press them together, sandwiching the adhesive film 36.

When the precut adhesive film 36 is sandwiched between the separator plates 14, it is separated from the remainder of the adhesive web 42 by virtue of the separator plates 14 being pressed against each other or by cutting.

The assembly station 40 is configured to run the adhesive web 42 through the assembly station 40, through the assembly press 46 in particular.

Optionally, the assembly station 40 includes a rewinder 54 for retrieving the adhesive web 42 downstream of the assembly press 46.

The separator plates 14 are held on the assembly press parts 48, 50 by a vacuum device, for example.

The creation of a vacuum between the assembly press part 48, 50 and a separator plate 14 allows the separator plate 14 to be retained on the assembly press part 48, 50, with removal of the vacuum allowing the separator plate 14 to be released.

The two assembly press parts 48, 50 are movable relative to each other between an open position, for positioning the sealing film 24 and the separator plate 14 between the two assembly press parts 48, 50 and a closed position, for pressing the sealing film 36 against the separator plate 14.

In one example embodiment, the assembly station 40 comprises a conveyor 55, such as a belt conveyor, with one of the assembly press parts 48 being supported by the conveyor 55 so that this assembly press part 48 can be moved along the assembly station 40.

In one example embodiment, one of the assembly press parts 50 is carried by an assembly robot 56, for example an assembly robot 56 having an articulated arm, in particular a six-jointed arm. The assembly robot 56 is configured to grasp a separator plate 14, press it onto another separator plate 14 while sandwiching the adhesive film 36 between the two separator plates 14, and then optionally grasp the assembly thus formed for storage, for example.

As illustrated in FIG. 4, the method for manufacturing a separator 4 comprises a sealing step comprising applying a sealing film 24 to the or each distribution face 16 of each separator plate 14 of the separator 4.

The application of a sealing film 24 to a distribution face 16 of a separator plate 14 is performed in a joining station 60.

The sealing film 24 is packaged as a sealing web 62, for example, with the sealing web 62 wound as a roll 64, for example.

As noted above, the sealing film 24 has a first adhesive (or glued) face 24A and a second non-adhesive (or not glued) face 24B.

In a known manner, the sealing web 62 is, provided on the adhesive face with a protective film (not shown), for example, to allow the sealing web 62 to be rolled up without adhering to itself.

For example, the sealing web 62 is precut to form sealing films 24 in the sealing web 62, with each sealing film 24 having the required lights (such as the main light 26 and the manifold lights 28).

The pre-cutting of the sealing films 24 is performed prior to winding the sealing web 62 to form the roll 64, for example.

In a variant, this is performed after unwinding the sealing web 62, in a cutting station located upstream of the joining station 60 along the path of the sealing web 62.

In the illustrated embodiment, the pre-cut sealing web 62 is unwound from the roll 64, the separator plate 14 of which one distribution face 16 is to receive a sealing film 24 is positioned opposite a sealing film 24 pre-cut from the sealing web 62 and the sealing film 24 is applied to the distribution face 16 of the separator plate 14.

The joining station 60 comprises a joining press 66, for example, including joining press parts 68, 70 configured to support the respective separator plate 14 and the sealing film 24 and press them together to adhere the sealing film 24 to the separator plate 14.

The two joining press parts 68, 70 are movable relative to each other between an open position, for positioning the sealing film 24 and the separator plate 14 between the two joining press parts 68, 70 and a closed position, for pressing the sealing film 24 against the separator plate 14.

The joining station 60 is configured to run the sealing web 62 through the joining station 60, in particular through the joining press 66.

Optionally, the joining station comprises a reel 72 for retrieving the sealing web 62 downstream of the joining press 66.

The separator plate 14 is held on the corresponding joining press part 68 by a vacuum device, for example.

In one example embodiment, the joining station 60 comprises a conveyor 74, such as a belt conveyor, with the joining press part 68 for receiving the separator plate 14 (alone or preassembled with another separator plate 14) being supported by the conveyor 74 so that this joining press part 68 carrying the separator plate 14 can be moved along the joining station 60.

In one embodiment, the joining press part 70 for applying the sealing film 24 against the separator plate 14 is carried by a joining robot 76, such as a joining robot 76 comprising an articulated arm, in particular a six-jointed articulated arm. The jointing robot 76 is configured to apply the joining press parts 68, 70 against each other, for example.

When the separator 4 comprises two assembled separator plates 14, the manufacturing method preferably comprises applying a sealing film 24 to the distribution face 16 of each of the two separator plates 14.

In one example embodiment, as shown in FIG. 4, the separator plates 14 are assembled prior to applying a sealing film 24 to the distribution face 16 of each of the separator plates 14.

In a variant, each separator plate 14 is provided with a sealing film 24 prior to assembling the two separator plates 14 with the interposition of an adhesive film 36 to form the separator 4.

One method for manufacturing an electrochemical reactor 2 comprises providing separator plates 14, providing membrane/electrode assemblies 6, manufacturing a plurality of separators 4, implementing the joining step, and, optionally, the assembly step described above if the separators 4 are formed by assembling two separator plates 14, and then manufacturing a stack of separators 4 and membrane/electrode assembly 6.

The invention is not limited to the above-described embodiments, as other embodiments are conceivable.

Instead of being provided in the form of an adhesive web 42, the adhesive films 36 may be provided in the form of individual sheets.

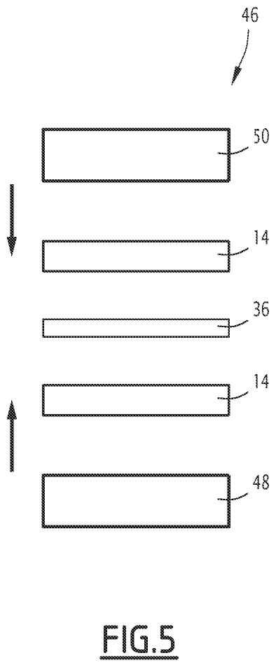

FIG. 5 illustrates the step of assembling two separator plates 14 using an adhesive film 36 supplied as an individual sheet, using an assembly station 40 comprising an assembly press 46.

The separator plates 14 are superimposed by sandwiching the adhesive film 36 and pressed by means of the assembly press 46.

Application of the adhesive film 36 can be done manually. Control over closing the assembly press 46 can be done manually.

In a variant, instead of being provided as a sealing web 62, the sealing films 24 may be provided as individual sheets.

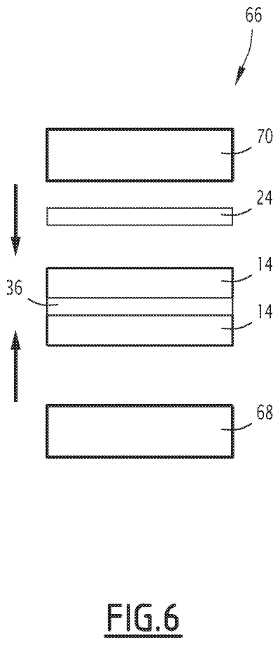

FIG. 6 illustrates the step of joining a separator plate 14, previously assembled to another separator plate 14, with a sealing film 24 supplied as an individual sheet, using a joining station 60 comprising a joining press 66.

The sealing film 24 is pressed against the separator plate by means of the joining press 68.

Application of the sealing film 24 can be done manually. Control over closing the joining press 66 can be done manually.

Also in this case, when a separator 4 is formed of two separator plates 14 stacked on top of each other, the separator plates 14 are joined together before applying a sealing film 24 to the distribution face 16 of each of the separator plates 14, or each separator plate 14 is provided with a sealing film 24 before joining the two separator plates 14 with an adhesive film 36 between them to form the separator 4.

In one example embodiment, as shown in FIGS. 3 and 5, the two separator plates 14 of the separator 14 are applied simultaneously on either side of the adhesive film 36.

The adhesive film 36, packaged as a separate adhesive web 42 or sheet, is pressed between two separator plates 14 as shown in FIG. 3 or FIG. 5.

In another example embodiment, the separator plates 14 are applied sequentially on either side of the adhesive film 36.

The adhesive film 36, packaged as an adhesive web 42 or separate sheets, is first applied to the assembly face 34 of one separator plate 14, in an application station, for example, and then another separator plate 14 is applied to the adhesive film 36 to form the assembly comprising the adhesive film 36 sandwiched between the two separator plates 14.

When the adhesive film 36 is packaged as an adhesive web 42, the application station (for applying the adhesive film 36 to one of the two separator plates 14) and the assembly station 40 (for pressing the separator plates 14 sandwiching the adhesive film 36) are arranged one behind the other along the path of the adhesive web 42, for example.

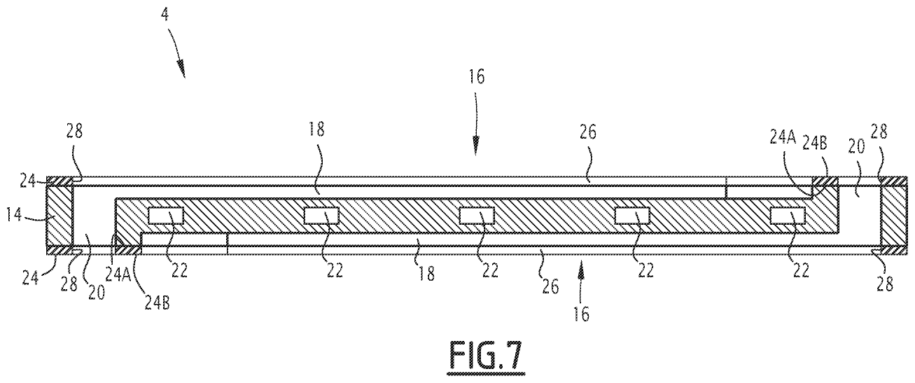

In a variant, in an example embodiment shown in FIG. 7, a separator 4 comprises a single separator plate 14 made of a single piece of material and configured with two distribution faces 16, in which case, preferably, the manufacturing method comprises applying a sealing film 24 to each of the two distribution faces 16 of the separator plate 14.

In such a case, the manufacturing method does not comprise a step of joining two separator plates 14 to form one separator 4, and the separator does not include an adhesive film 36 for joining two separator plates 14.

Further, the separators 4 shown in FIGS. 2 and 7 are bipolar separators 4, with each separators 4 intended to be interposed between two membrane/electrode assemblies 6 in an alternating stack of separators 4 and membrane/electrode assemblies 6, channeling a fluid along each of the two membrane/electrode assemblies 6 located on either side of the separator 4.

In another example embodiment, a separator 4 is monopolar, intended to seal with a single membrane/electrode assembly 6. It has a single distribution face 16.

1. A method for manufacturing a separator for an electrochemical reactor formed of a stack of separators and membrane/electrode assemblies defining superimposed electrochemical cells, the manufacturing method comprising providing a separator plate comprising a distribution face configured to channel a fluid along a face of a membrane/electrode assembly applied against the separator plate and applying a sealing film to the distribution face of the separator plate to ensure the seal between the separator plate and the membrane/electrode assembly and/or a another separator sandwiching the membrane/electrode assembly with the separator, the sealing film being adhesive on a first face thereof facing the separator plate to adhere to the separator plate, the sealing film being non-adhesive on a second face thereof, opposite the separator plate.

2. The manufacturing method according to claim 1, wherein the sealing film is precut to provide lights in the sealing film prior to being applied to the separator plate.

3. The manufacturing method according to claim 1, wherein the sealing film is applied to the separator plate using a sealing press configured to press the sealing film against said distribution face of the separator plate.

4. The manufacturing method according to claim 3, wherein the joining press comprises two joining press parts movable relative to each other between an open position, for positioning the sealing film and the separator plate between the two press parts, and a closed position, for pressing the sealing film against the separator plate.

5. The manufacturing method according to claim 1, wherein the sealing film is provided as a single sheet or as a sealing web comprising a series of sealing films.

6. The manufacturing method according to claim 1, comprising assembling the separator plate with another separator plate by superimposing and assembling two separator plates by means of an adhesive film, adhesive on both sides, interposed between the two separator plates.

7. The manufacturing method according to claim 6, wherein the adhesive film is pre-cut so as to provide windows in the adhesive film prior to interposition of the adhesive film between the two separator plates.

8. The manufacturing method according to claim 6, wherein the adhesive film is provided as a sheet or as an adhesive tape comprising a series of adhesive films.

9. The manufacturing method according to claim 6, wherein the adhesive film has a thickness strictly less than that of the sealing film applied to the separator plate.

10. The manufacturing method according to claim 6, wherein the other separator plate is provided with a sealing film on the distribution face facing away from the separator plate, this sealing film being adhesive on a first face thereof facing the other separator plate in order to adhere to the other separator plate, this sealing film being non-adhesive on a second face thereof opposite the other separator plate.

11. Method for producing an electrochemical reactor formed by a stack of separators and membrane/electrode assemblies defining superposed electrochemical cells, the stack being made using one or more separator(s) obtained according to the manufacturing method of claim 1.

12. An electrochemical reactor separator comprising a separator plate having a distribution face configured to channel a fluid along a face of a membrane/electrode assembly applied against said distribution face, and a sealing film deposited on the distribution face of the separator plate for sealing the membrane/electrode assembly and/or another separator sandwiching the membrane/electrode assembly with the separator, the sealing film being adhesive on a first face facing the separator plate to adhere to the separator plate, and being non-adhesive on a second face opposite the separator plate.

13. The separator according to claim 12, comprising another separator plate assembled with the separator plate by means of an adhesive film interposed between the two separator plates.

14. The separator according to claim 13, wherein the other separator plate has a distribution face on the side opposite the separator plate, the separator comprising a sealing film deposited on said distribution face of the other separator plate, this sealing film being adhesive on a first face thereof facing the other separator plate to adhere thereto and non-adhesive on a second face thereof opposite the other separator plate.

15. An electrochemical reactor formed of a stack of separators and membrane/electrode assemblies defining superimposed electrochemical cells, the stack including one or more separator(s) according to claim 12.

16. The manufacturing method according to claim 2, wherein the sealing film is provided as a single sheet or as a sealing web comprising a series of sealing films.

17. The manufacturing method according to claim 3, wherein the sealing film is provided as a single sheet or as a sealing web comprising a series of sealing films.

18. The manufacturing method according to claim 4, wherein the sealing film is provided as a single sheet or as a sealing web comprising a series of sealing films.
